(19) United States
(12) Patent Application Publication
(10) Pub. No.: US 2004/0085571 A1
(43) Pub. Date: May 6, 2004

(54) Method of transmitting data

(76) Inventors: Greg Hulan, Poway, CA (US); Daniel Wee, San Diego, CA (US)

Correspondence Address: HEWLETT-PACKARD COMPANY, Intellectual Property Administration, P.O. Box 272400, Fort Collins, CO, 80527-2400, US

(21) Appl. No.: 10/285,111

(22) Filed: Oct. 30, 2002

(51) Int. Cl. G06F 15/00; H04N 1/32

(52) U.S. Cl. 358/1.15; 358/434

(57) ABSTRACT

A method of transmitting facsimile data is provided, the method including providing an origination facsimile device connected to a computer network, the origination facsimile device being configured to transmit page data of a current facsimile job. Prior to commencing transmission of the page data, it is determined whether a destination facsimile device is currently connected to the computer network such determination being made at the origination facsimile device. If the destination facsimile device is determined to be connected to the computer network, a computer network communications link between the origination facsimile device and the destination facsimile device is established via the computer network. Page data thus is transmitted between the origination facsimile device and the destination facsimile device via the computer network communications link.

### BACKGROUND

The use of facsimile machines has grown in recent years at a tremendous rate. Every day, users at home and work send documents across town, across the country, and to destinations overseas using local, long distance, and international telephone networks. Current facsimile technologies are only capable of transmitting data over these telephone networks at relatively slow rates, resulting in lengthy connect times for each facsimile call. These lengthy connect times may potentially inconvenience the user and/or recipient, especially when time is of the essence, and also tie up valuable telephone line resources. In addition, significant long distance and local telephone charges often result. Telephone bills for these facsimile calls can run thousands of dollars per month even for a small business. It would be desirable to provide a faster and more cost-efficient method, system, and device for transmitting facsimile data.

### SUMMARY

A method of transmitting facsimile data is provided, the method including providing an origination facsimile device connected to a computer network, the origination facsimile device being configured to transmit page data of a current facsimile job. Prior to commencing transmission of the page data, it is determined whether a destination facsimile device is currently connected to the computer network such determination being made at the origination facsimile device. If the destination facsimile device is determined to be connected to the computer network, a computer network communications link between the origination facsimile device and the destination facsimile device is established via the computer network. Page data thus is transmitted between the origination facsimile device and the destination facsimile device via the computer network communications link.

### BRIEF DESCRIPTION OF THE DRAWINGS

FIG. 1 is a schematic view of a system for transmitting facsimile data over a computer network according to one embodiment of the present invention.

FIG. 2 is a schematic view of facsimile data of the system of FIG. 1.

FIG. 3 is a more detailed schematic view of the system of FIG. 1.

FIG. 4 is a flow diagram illustrating messages sent between an origination device and destination devices of the system of FIG. 1.

FIG. 5 is a detailed schematic view of a user interface shown in FIG. 3.

FIG. 6 is a schematic view of a system for transferring information according to one embodiment of the present invention.

FIG. 7 is a flowchart of a method for transmitting facsimile data over a computer network according to one embodiment of the present invention.

FIG. 8 is a flowchart of a method for transmitting facsimile data over a computer network according to another embodiment of the present invention.

FIG. 9 is a flowchart of a method for transmitting facsimile data over a computer network according to yet another embodiment of the present invention.

### DETAILED DESCRIPTION

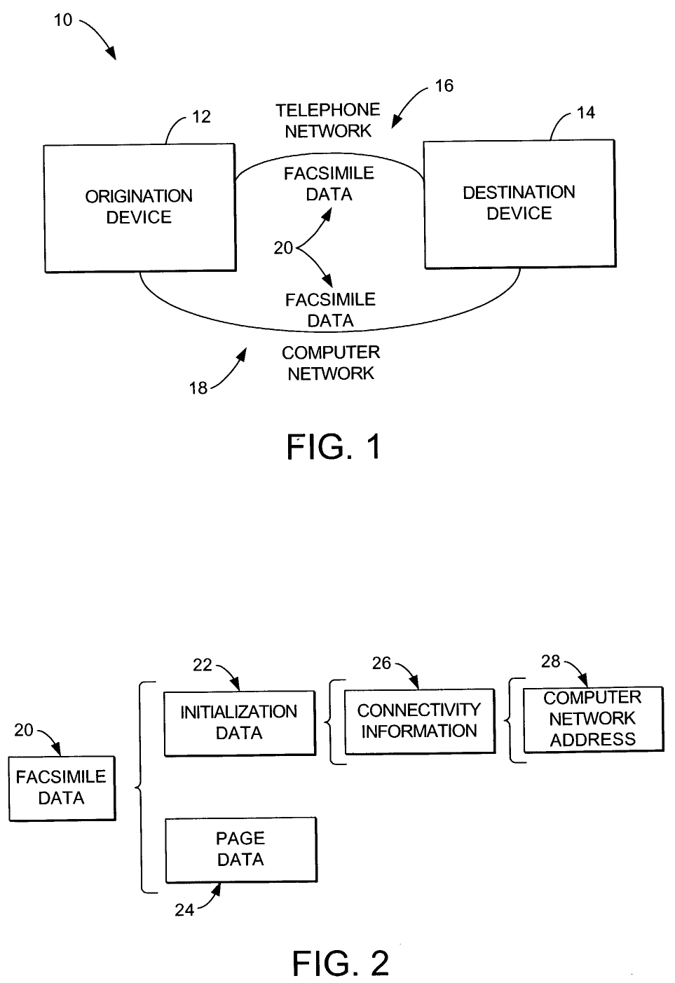

FIG. 1 shows, generally at 10, a system for transmitting facsimile data over a telephone network and/or a computer network to a destination device configured to receive facsimile data according to one embodiment of the present invention. System 10 typically includes an origination device 12 configured to determine whether a communication link may be established between origination device 12 and a destination device 14 over a computer network 18. If the destination device is determined to be connected to the computer network, then the origination device may be configured to transmit facsimile data 20 over the computer network to destination device 14.

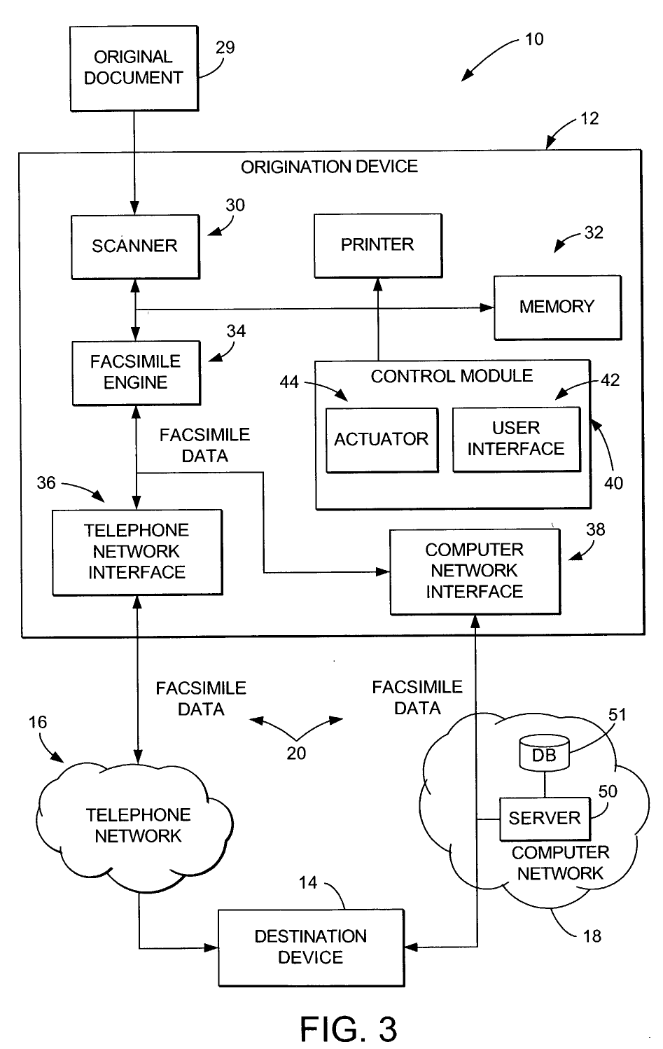

Origination device 12 is typically configured to determine if destination device 14 is connected to computer network 18 by initiating a communication link with the destination device via telephone network 16 and receiving connectivity information, as a part of facsimile data 20, from the destination device. Alternatively, origination device 12 may be configured to determine if the destination device is connected to a computer network by contacting a messaging server 50 (shown in FIG. 3) via the computer network to obtain the connectivity information for the destination device. It will be appreciated that the origination device may also be configured in virtually any other alternative manner suitable for determining if the destination device is connected to the computer network.

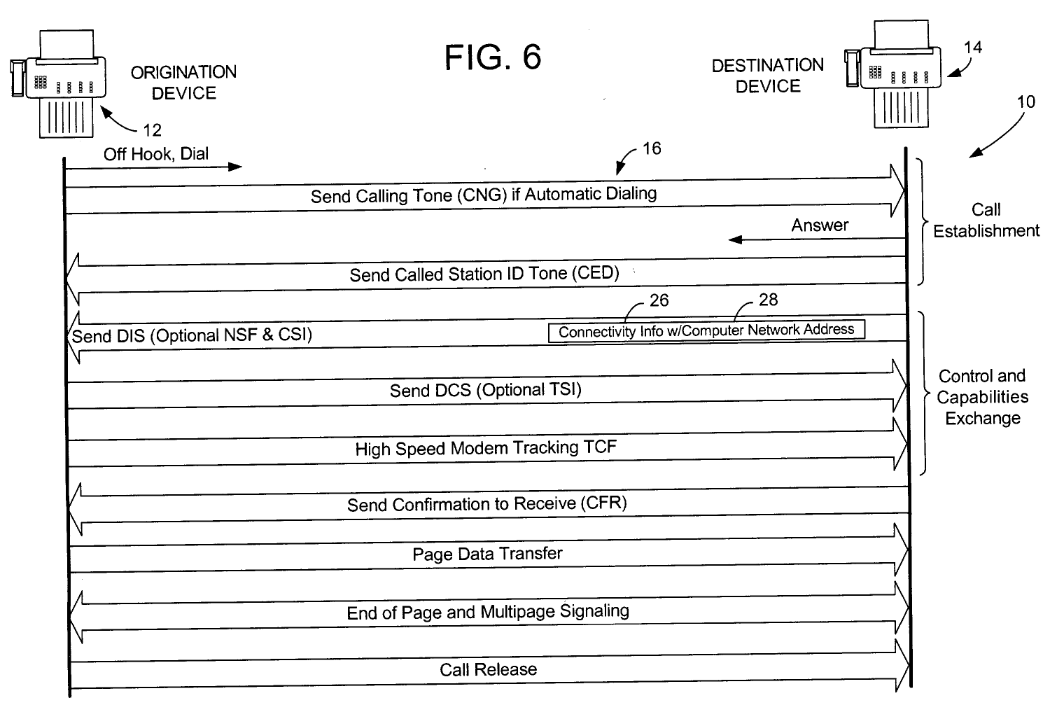

As shown in FIG. 2, facsimile data 20 typically includes initialization data 22 and page data 24. Initialization data 22 typically includes messages exchanged between origination device 12 and destination device 14 in order to set up a facsimile connection for a current facsimile job, via the telephone network and/or the computer network, as explained in detail below with reference to FIG. 6. Initialization data 22 typically includes connectivity information 26 which in turn may include a computer network address 28 of the destination device.

Page data 24 is typically the data that represents the pages of the document that were scanned into the origination device for the current facsimile job. After being transmitted from the origination device to the destination device, page data 24 is typically printed out by the destination device, thereby creating a facsimile representation of an original document.

Origination device 12 is typically a facsimile machine, but may be a multi-function facsimile device that is capable of scanning, printing, copying, faxing, etc. As shown in FIG. 3, origination device 12 may include a scanner 30 configured to scan an image of an original document 29, and to store the scanned image as page data in memory 32. A facsimile engine 34 may be configured to transmit facsimile data 20 to destination device 14 over telephone network 16, which is typically a Public Switched Telephone Network (PSTN), via a telephone network interface 36. Facsimile engine 34 also may be configured to transmit facsimile data 20, to destination device 14 over computer network 18 via computer network interface 38. While origination device 12 typically connects to the telephone network and the computer network over separate, dedicated connections, it will be appreciated that one physical line may be used.

Origination device 12 may further include a control module 40 that is typically configured to control operations of origination device 12. Control module 40 may be configured to communicate with the destination device via the telephone network to determine if the destination device is currently connected to the computer network. It will be appreciated that this determination may be accomplished in virtually any other way that allows this determination by the origination device. Control module 40 typically includes a user interface 42 having at least one associated actuator 44 used to input commands to control module 40. User interface 42 is typically configured to display information and to allow a user to view and select destination devices to receive data from the origination device. Control module 40 may be further configured to query a server 50, and thereby, to identify one or more destination devices that are currently connected to the network.

Upon determination that destination device 14 is connected to computer network 18, the origination device may be configured to terminate the communication link via the telephone network and to cause facsimile engine 34 to send facsimile data 20 to destination device 14 over the computer network 18, thus saving in long-distance and other telephone charges otherwise associated with facsimile transmissions. If destination device 14 is not connected to computer network 18, or any other computer network that origination device 12 is connected to, origination device 12 may be configured to transmit facsimile data 20 to destination device 14 over telephone network 16.

Destination device 14 may be configured to receive the facsimile data from origination device 12 via a telephone network 16 and/or computer network 18. Destination device 14 is typically a facsimile machine, but may be a multifunction facsimile device with scanning and printing functionality, or virtually any other device capable of receiving facsimile data. As indicated, telephone network 16 is typically the Public Switched Telephone Network (PSTN), but may be any other type of network capable of carrying telephone data transmissions, including, but not limited to, a wireless network. Computer network 18 is typically a wide-area network (WAN), such as the Internet, but may alternatively be a private, secure WAN, such as a virtual private network. Alternatively, a local area network (LAN), wireless network, or other computer network may be utilized.

In alternative embodiments, the origination device 14 may determine if the destination device can receive facsimile data over the computer network 18 instead of the telephone network 16 by using other means. For example, the computer network 18 may include a server 50 configured to respond to queries from the origination device, and to indicate whether the destination device is currently on-line. Because of its role in indicating to peer devices whether another peer is online, server 50 may be referred to as a “messaging” server, even though the actual facsimile message may not travel through the server at all, but may be sent in a peer-to-peer manner from origination device to the destination device, as discussed below.

Each of the destination device and the origination device are typically pre-registered with server 50. Server 50 and database 51 are configured to store the computer network address of each device, a “handle” (or screen name) for each device, an indicator of whether the device is currently on-line, and a list of “friends” for each device. In the depicted embodiment, the destination device is listed as a “friend” of the origination device, and vice versa. The “friends” may also be referred to as group members.

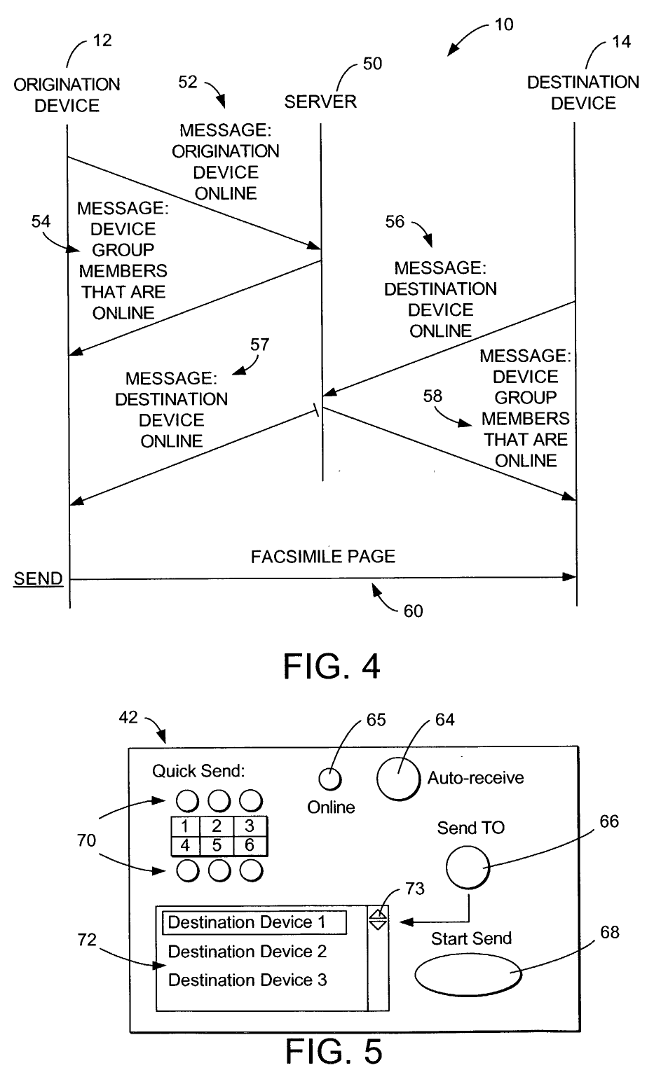

As shown in FIG. 4, after pre-registration of the origination device and destination device with server 50, upon connection of origination device 12 to the computer network, origination device 12 may be configured to send a message 52 to server 50, notifying server 50 that origination device 12 is currently connected to a computer network. Server 50 may be configured to acknowledge the notification, and to store an identifier in associated database 51 (see FIG. 3), indicating that the destination device is online. The identifier may be described as being pre-registered on the server, since it is placed on the server prior to commencement of the transmission of page data between the origination and destination devices. Typically, the identifier includes an associated computer network address of the destination device. Server 50 also may be configured to determine which associated devices, i.e. “friends” or group members, of the origination device are currently on-line, and to send a message 54 notifying origination device 12 that these group members are on-line.

Destination device 14 may undergo a similar sequence by sending a notification message 56, notifying server 50 that destination device 14 is connected to the computer network. Upon receiving message 56, server 50 may send a message 57 to the origination device and other devices that list destination device 14 as a “friend” or group member, indicating that the destination device 14 is now online. Server 50 also may be configured to determine which “friends” or group members of the destination device are currently on-line, and to send a message 58 notifying destination device 14 of the group members that are on-line.

If origination device 12 has information that destination device 14 is currently connected to the computer network, then origination device 12 may be configured to present an option to a user to transmit facsimile data directly from origination device 12 to destination device 14, as indicated at 60. Typically, this facsimile data does not travel through server 50, but rather travels directly from the origination device to the destination device. Origination device 12 may store the computer network address of the destination device in non-volatile memory. It will be appreciated that the computer network address of the destination device may be stored in any manner that allows the origination device to access it.

FIG. 5 shows an exemplary user interface 42 of origination device 12 and destination device 14. User interface 42 typically includes an auto-receive actuator 64 that, when actuated, may enable a user to toggle an auto-receive function. If the auto-receive function is activated, then the device may notify a server that it is currently connected to a network and ready to receive data. This state is typically referred to as being “on-line,” and is indicated by on-line indicator 65, typically an LED. If the auto-receive function is deactivated, the notification to the server is not made and the device is typically unable to receive data. In this state, the device is referred to as being “off-line,” and the on-line indicator is typically turned off.

User interface 42 may further include a “send to” actuator 66 that, when actuated, may cause a list of associated devices (or “friends”) that are either online or off-line to be displayed on screen 72, which is typically an LCD screen. The user may then scroll through the list via associated toggle buttons 73 to select which device data is to be transmitted by the device. Upon reaching a desired device, the user may depress a “start send” actuator 68 to begin sending a facsimile job to the selected destination device. It will be appreciated that screen 72 may alternatively be touch sensitive and incorporate graphic icons that function as actuators 64, 66, 68, as well as the other actuators discussed below.

User interface 42 may further include one or more “one-touch send” actuators 70. One-touch send actuators 70 may be programmed to connect the origination device to a specific destination device, and to send the facsimile data thereto. Thus, actuators 70 may be used by a user to send facsimile data to the associated destination device with one press of a button.

As shown in FIG. 6, a facsimile call sent over the PSTN may be divided into five phases (assuming no errors are encountered), namely, call establishment, control and capabilities exchange, page data transfer, end of page and multipage signaling, and call release. First, during the call establishment phase, the fax call may be established either through a manual process, where a user dials a call and puts the origination device 12 into fax mode, or by automatic procedures, in which no human interaction is required. In both cases, the destination device 14 typically returns an answer tone, referred to as a called station identification (CED). This is a high-pitched tone often heard when connecting to a fax machine. If the call is automatically dialed, the origination device may also indicate the fax call with a calling tone (CNG), which is a short, periodic tone that begins immediately after the number is dialed. These tones are generated to allow a human participant to realize that a machine is present on the other end of the call.

Next, the control and capabilities exchange phase of the fax call may be used to identify the capabilities of the device at the other end of the call. It also may negotiate the acceptable conditions for the call. The exchange of control messages throughout the fax call typically are sent using the low-speed (300 bps) modulation mode. Every control message may be preceded by a one-second preamble, which allows the communication link to be conditioned for reliable transmission.

The destination device typically begins the procedure by sending a digital identification signal (DIS) message, which contains the capabilities of the destination device. An example of a capability that could be identified in this message is the support of the V.17 (14,000 bps) data signaling rate. At the same time, the called subscriber information (CSI) and nonstandard facilities (NSF) messages are optionally sent. NSF are capabilities that a particular manufacturer has built into a device to distinguish its product from others.

In order to determine whether destination device 14 is connected to the 5 computer network, the destination device and the origination device of the present embodiment are typically configured to exchange connectivity information 26 as one or more NSF messages during the control and capabilities exchange portion of the facsimile call. The NSF-encoded connectivity information 26 typically includes an indication of whether the destination device is currently 10 connected to the computer network, and if so, the current computer network address 28 of the destination device.

Once the origination device receives connectivity information 26 via the NSF messages, and determines that the destination is currently connected to the computer network, it is typically configured to terminate the facsimile call prior to sending any page data. The origination device then may establish a connection to the destination device via the computer network, and transmit the page data of the current facsimile job over the computer network connection, thereby avoiding telephone line charges otherwise associated with facsimile calls.

Conventional fax calls placed over a telephone network typically proceed through the remaining phases shown in FIG. 6, including high-speed modem tracking, confirmation to receive, page data transfer, end of page and multipage signaling, and call release. But, upon establishing the connection to the destination device via the computer network, the origination device of the present invention is configured to release the call, without proceeding through each of the steps shown in FIG. 6, thereby minimizing telephone charges associated with the facsimile call.

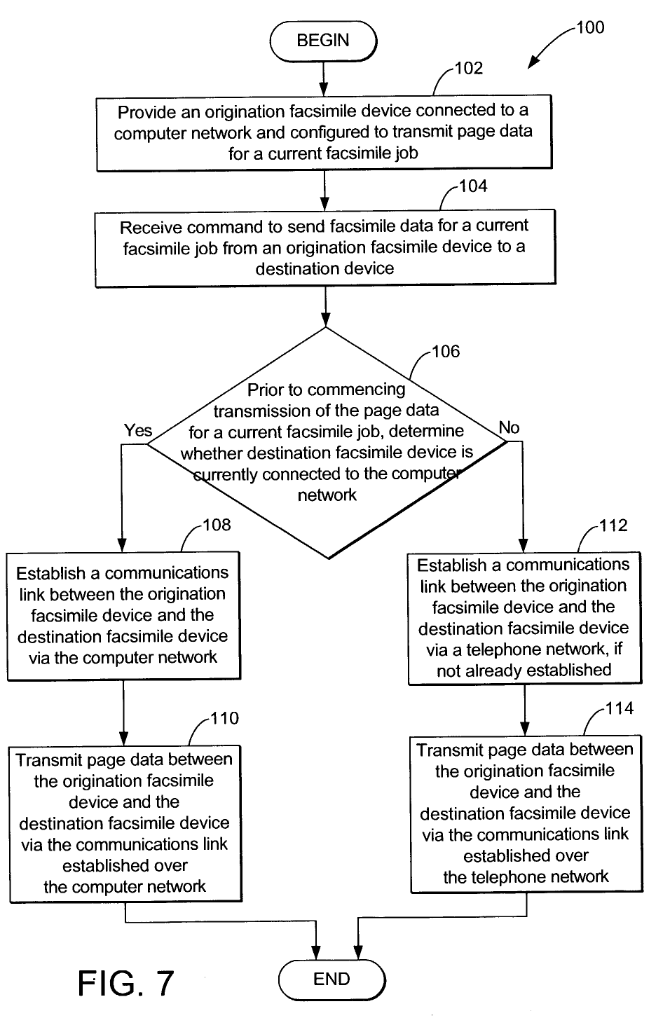

Turning now to FIG. 7, a method according to one embodiment of the present invention is shown generally at 100. Method 100 includes, at 102, providing an origination facsimile device. The origination facsimile device typically is able to communicate over a computer network (e.g., the internet) connected to a computer network. The origination facsimile device is also typically configured to transmit page data for a current facsimile job, as described above.

At 104, method 100 includes receiving a command to send facsimile data for a current facsimile job from an origination facsimile device to a destination device. At 106, method 100 includes determining whether the destination facsimile device is currently connected to the computer network. This determination is typically made at the origination facsimile device, prior to commencing transmission of the page data for the current facsimile job from the origination facsimile device. The origination facsimile device may make this determination at least in part by initiating a communication link with the destination facsimile device via a telephone network and receiving connectivity information from the destination facsimile device over the telephone network.

The connectivity information may include an indication of whether the destination device is currently on-line or off-line, as well as a current computer network address of the destination device. Alternatively, the origination facsimile device may determine if the destination facsimile device is connected to a computer network by contacting a messaging server via the computer network to obtain the connectivity information for the destination facsimile device. It will be appreciated that the origination facsimile device may also obtain this connectivity information by other suitable methods for determining that the destination facsimile device is connected to the computer network.

The origination facsimile device typically makes this determination before transmitting any of the page data to the destination facsimile device. However, it will be appreciated that the origination facsimile device may make this determination at virtually any time during the communication link. For example, after sending a fraction of the page data in a facsimile job to the destination device, the origination device may be configured to detect that the destination device is connected to a computer network.

At 108, the method 100 includes establishing a communications link between the origination facsimile device and the destination facsimile device via the computer network. This is typically accomplished if the destination facsimile device is determined to be connected to the computer network.

At 110, method 100 includes transmitting page data between the origination facsimile device and the destination facsimile device via the communications link established over the computer network.

If it is determined at 106 that the destination facsimile device is not currently connected to the computer network, method 100, at 112, includes establishing a telephone network communications link between the origination facsimile device and the destination facsimile device via a telephone network, if such a telephone network connection is not already established. At 114, the method further includes transmit page data between the origination facsimile device and the destination facsimile device via the communications link established over the telephone network.

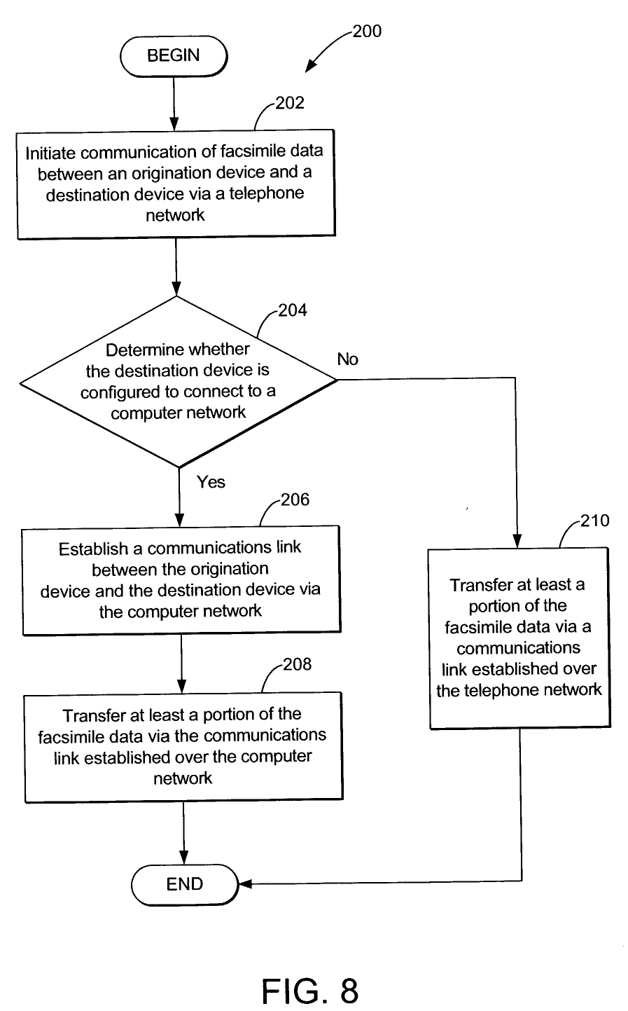

In FIG. 8, a method according to another embodiment of the present invention is shown generally at 200. Method 200 includes, at 202, initiating communication of facsimile data between an origination device and a destination device via a telephone network. Initiating of communication of facsimile data may include exchanging initialization data between the origination device and the destination device. The initialization data may include connectivity information such as an indication of whether the destination device is currently connected to a computer network, and if so, the computer network address of the destination device.

At 204, method 200 includes determining whether the destination device is configured to connect to a computer network. The origination device typically determines whether the destination device is connected to the computer network by initiating a communication link with the destination device via a telephone network and receiving connectivity information from the destination device. Alternatively, the origination device may determine if the destination device is connected to a computer network by contacting a messaging server via the computer network to obtain connectivity information of the destination device, as discussed above.

At 206, method 200 includes establishing a communications link between the origination device and the destination device via the computer network. A communication link is established if the destination device is determined to be connected to the computer network.

At 208, method 200 includes transferring at least a portion of the facsimile data via the communications link established over the computer network. Typically, facsimile data includes initialization data and page data, and some or all of the page data is transferred via the computer network. It will also be appreciated that some initialization data may also be exchanged between the origination device and the destination device via the computer network, in order to facilitate the transmission of facsimile data between the devices.

If it is determined at 204 that the destination device is not currently connected to the computer network, method 200 typically further includes, at 210, transferring at least a portion of the facsimile data via a communications link established over the telephone network.

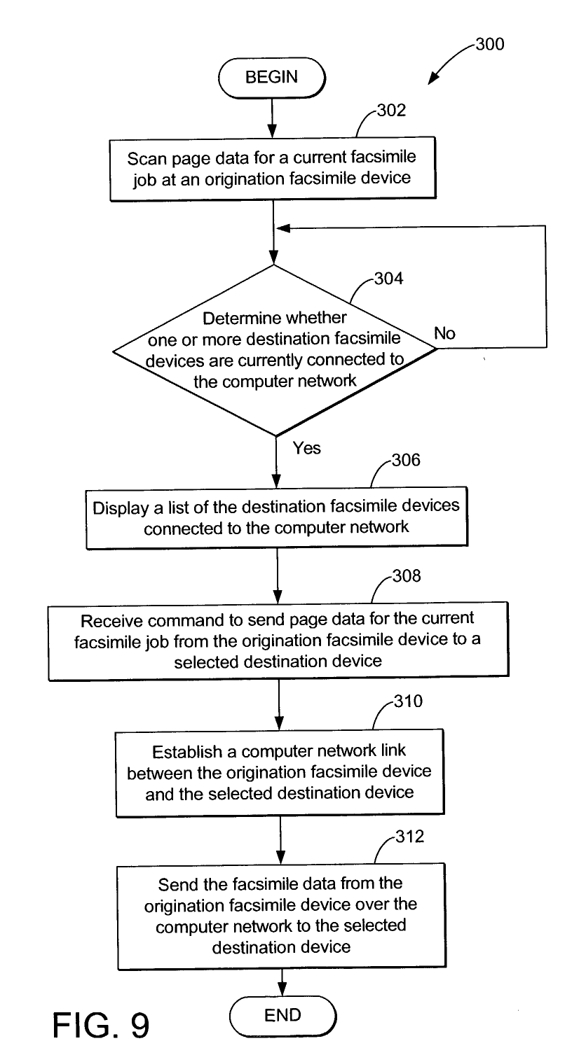

In FIG. 9, a method according to another embodiment of the present invention is shown generally at 300. Method 300 includes scanning page data for a current facsimile job at an origination facsimile device, at 302. This scanned data may be stored, at least temporarily as page data in the memory of the of the origination device. A facsimile job may include one or more pages of page data.

At 304, method 300 includes determining whether one or more destination devices are currently connected to the computer network, the determination being made at the origination facsimile device. The origination facsimile device may determine if a destination device is connected to the computer network by initiating a communication link with the destination device via a telephone network and receiving connectivity information from the destination device. Alternatively, the origination facsimile device may determine if a destination device is connected to a computer network by contacting a messaging server via the computer network to obtain connectivity information of the destination device, as described above.

At 306, the method 300 includes displaying a list of the destination facsimile devices connected to the computer network. At 308, the method includes receiving a command to send page data for the current facsimile job from the origination facsimile device to a selected destination device.

At 310, method 300 includes establishing a computer network link between the origination facsimile device and the destination device. Typically, the computer network link is established only if the destination device is determined to be connected to the computer network. At 312, method 300 includes sending at least a portion of the facsimile data from the origination facsimile device over the computer network to the destination device.

While the present invention has been particularly shown and described, those skilled in the art will understand that many variations may be made therein without departing from the spirit and scope defined in the following claims. The description should be understood to include all novel and non-obvious combinations of elements described herein, and claims may be presented in this or a later application to any novel and non-obvious combination of these elements. Where the claims recite “a” or “a first” element or the equivalent thereof, such claims should be understood to include incorporation of one or more such elements, neither requiring nor excluding two or more such elements.

What is claimed is:

1. A method of transmitting facsimile data including page data, the method comprising:
providing an origination facsimile device connected to a computer network, the origination facsimile device being configured to transmit page data of a current facsimile job;
prior to commencing transmission of the page data, determining whether a destination facsimile device is currently connected to the computer network, the determination being made at the origination facsimile device;
if the destination facsimile device is determined to be connected to the computer network, then establishing a computer network communications link between the origination facsimile device and the destination facsimile device via the computer network; and
transmitting page data between the origination facsimile device and the destination facsimile device via the computer network communications link.

2. The method of claim 1, further comprising:
initiating telephone communication between the origination facsimile device and the destination facsimile device via a telephone network.

3. The method of 2, wherein determining whether a destination facsimile device is currently connected to the computer network is accomplished at least in part by transmitting connectivity information over the telephone network between the origination facsimile device and the destination facsimile device.

4. Then method of claim 3, wherein the transmitting occurs at exchange of initialization data of a facsimile call.

5. The method of claim 1, wherein determining whether a destination facsimile device is currently connected to the computer network is accomplished at least in part by communicating with a messaging server to identify whether the destination facsimile device is currently connected to the computer network.

6. The method of claim 1, wherein if the facsimile device is not determined to be connected to the computer network, then transmitting page data between the origination device and the destination device via a telephone network.

7. A method of transmitting data comprising:
initiating telephone communication of facsimile data between an origination device and a destination device via a telephone network;
determining whether the destination device connected to a computer network;
if the destination device is determined to be connected to the computer network, then establishing a computer network communications link between the origination device and the destination device via the computer network; and
transferring at least a portion of the facsimile data via the computer network communications link.

8. The method of claim 7, further comprising:
upon establishing a computer network communications link between the origination device and the destination device, terminating the telephone communication between the origination device and the destination device, after sending at least a portion of the facsimile data over the telephone network.

9. The method of claim 7, further comprising;
if the destination device is determined to be connected to the computer network, then receiving a computer network address of the destination device via the telephone network.

10. The method of claim 7, wherein the facsimile data includes:
initialization data and page data.

11. The method of claim 10, further comprising:
sending at least a portion of the initialization data from the origination device via the telephone network.

12. The method of claim 10, further comprising:
receiving at least a portion of the initialization data at the destination device via the telephone network.

13. The method of claim 10, further comprising:
sending at least a portion of the page data from the origination device via the computer network.

14. The method of claim 10, further comprising:
receiving at least a portion of the page data at the destination device via the computer network.

15. A method of transmitting facsimile data including page data via a computer network, the method comprising:
scanning page data for a current facsimile job at an origination facsimile device;
determining whether a destination device is currently connected to the computer network, the determination being made at the origination facsimile device;
if the destination device is determined to be connected to the computer network, then establishing a computer network link between the origination facsimile device and the destination device; and
sending the facsimile data from the origination facsimile device over the computer network to the destination device.

16. The method of claim 15, wherein determining includes:
identifying the destination device via an identifier stored on a server.

17. The method of claim 16, wherein the identifier is preregistered on the server.

18. The method of claim 16, wherein the identifier includes a computer network address of the destination device.

19. The method of claim 18, further comprising:
receiving the computer network address of the destination device from the server.

20. The method of claim 19, further comprising:
storing the computer network address of the destination device in non-volatile memory.

21. The method of claim 15, wherein the destination device is one of a plurality of destination devices associated with the origination facsimile device via the server.

22. The method of claim 15, further comprising:
printing the facsimile data at the destination device.

23. A system for transmitting facsimile data over a telephone network and/or a computer network to a destination device configured to receive facsimile data, the system comprising:
an origination facsimile device connected to a computer network, the origination facsimile device being configured to transmit page data of a current facsimile job; and
a destination facsimile device configured to connect to a computer network, and also configured to receive page data for a current facsimile job;
wherein prior to commencing transmission of the page data, the origination device is configured to determine whether the destination facsimile device is currently connected to the computer network, the determination being made at the origination facsimile device; and
wherein, if the destination facsimile device is determined to be connected to the computer network, the origination device is further configured to establish a computer network communications link between the origination facsimile device and the destination facsimile device via the computer network, and to transmit page data between the origination facsimile device and the destination facsimile device via the computer network communications link.

24. The system of claim 23, wherein the origination device is configured to initiate communication with the destination device via a telephone network.

25. The system of claim 24, wherein the origination device is configured to transmit connectivity information over the telephone network to the origination device.

26. The system of claim 23, wherein the origination device is configured to communicate with a messaging server to identify whether the destination device is currently connected to the computer network.

27. A system for transmitting facsimile data over a computer network to a destination device, the system comprising:
an origination facsimile device configured to scan an image of a document for transmission as facsimile data;
a server coupled to the origination facsimile device and to each of a plurality of destination devices, the server having an associated database configured to store computer network addresses for the plurality of destination devices in a registry; and
wherein each of the plurality of destination devices is configured to contact the server upon connecting to the computer network, and to communicate to the server that it is available on-line;
wherein, in response to user input of a selected destination device, the origination facsimile device is configured to communicate with the server to determine whether the selected destination device is available on-line, and if available, is further configured to determine the computer network address of the destination device from the registry in the database associated with the server, and send the facsimile data over the computer network to the selected destination device.

28. The system of claim 27, wherein the destination device is configured to print the facsimile data.

29. A facsimile device comprising:
a scanner configured to scan an image of a document;
a facsimile engine coupled to the scanner, the facsimile engine being configured to transmit the scanned image as facsimile data to a destination device via either of a telephone network or a computer network;
a control module configured to query a remote server, and thereby to identify one or more destination devices that are currently connected to the computer network; and
a user interface configured to display the one or more destination devices that are currently connected to the computer network;
wherein the user interface includes an actuator that, upon actuation by a user, is configured to cause the facsimile engine to send the facsimile data to one or more selected destination device(s), over the computer network.

30. The device of claim 29, further comprising:
a printer configured to print the scanned image.

31. A facsimile device comprising;
a scanner configured to scan an image of a document;
a facsimile engine coupled to the scanner, the facsimile engine being configured to transmit the scanned image as facsimile data to a destination device via either of a telephone network and a computer network;
a control module configured to communicate with the destination device via the telephone network to determine if the destination device is currently connected to the computer network; and
an actuator that, upon actuation by a user, is configured to cause the facsimile engine to send the facsimile data to the destination device, over the computer network, provided that the destination device is determined to be connected to the computer network by the control module.

32. The device of claim 31, further comprising:
a user interface configured to display the one or more destination devices that are currently connected to the network.

33. The device of claim 31, wherein the actuator is a button.

34. A storage medium readable by a computer, having embodied therein
a program of instructions executable by the computer to perform the steps of:
providing an origination facsimile device connected to a computer network, the origination facsimile device being configured to transmit page data for a current facsimile job;
prior to commencing transmission of the page data for the current facsimile job from the origination facsimile device, determining whether a destination facsimile device is currently connected to the computer network, the determination being made at the origination facsimile device;
if the destination facsimile device is determined to be connected to the computer network, then establishing a communications link between the origination facsimile device and the destination facsimile device via the computer network; and
transmitting page data between the origination facsimile device and the destination facsimile device via the communications link established over the computer network.

35. The method of claim 34, further comprising:
initiating communication between the origination facsimile device and the destination facsimile device via a telephone network.

36. The method of 35, wherein determining is accomplished at least in part by transmitting connectivity information over the telephone network between the origination facsimile device and the destination facsimile device.

37. Then method of claim 36, wherein the transmitting occurs at the exchange of initialization data of a facsimile call.

38. The method of claim 34, wherein determining is accomplished at least in part by communicating with a messaging server to identify whether the destination facsimile device is currently connected to the computer network.
